(19) United States
(12) Patent Application Publication
(10) Pub. No.: US 2023/0051459 A1
(43) Pub. Date: Feb. 16, 2023

(54) ROBOTIC LAWN MOWER OF NON-TRADITIONAL CUTTER

(71) Applicant: TEXAROBA TECHNOLOGY INC., Plano, TX (US)

(72) Inventor: Jia SONG, Tulsa, OK (US)

(73) Assignee: TEXAROBA TECHNOLOGY INC., Plano, TX (US)

(21) Appl. No.: 17/797,182

(22) PCT Filed: Feb. 5, 2021
(86) PCT No.: PCT/US2021/016951

§ 371 Date: Aug. 3, 2022

Related U.S. Application Data
(60) Provisional application No. 62/971,805, filed on Feb. 7, 2020.

(51) Int. Cl. A01D 34/00; A01D 34/78; A01D 34/416

(52) U.S. Cl. CPC A01D 34/008; A01D 34/78; A01D 34/416; A01D 2101/00

(57) ABSTRACT

The present invention relates to a robotic lawn mower. The lawn mower comprises a housing having an upper cover portion and a chassis as a carrying platform; a mowing assembly mounted on the front section of the chassis and having two sets of rotatable cutting tools, and a moving assembly having four moving wheels that are mounted on the sides of the chassis; and a control unit for controlling the operation of the mowing assembly and moving assembly; as well as a power source providing power to the mowing assembly for the rotation of the cutting tools and the moving assembly for driving the lawn mower in any or all directions without necessity of turning the front or head of the mower. The cutting tools are formed of semi rigid and semi flexible material, and in the form of short rod or twisted cables or wires.

### CROSS-REFERENCE TO RELATED APPLICATIONS

The present application claims priority to U.S. Provisional Patent Application No. 62/971,805, filed on Feb. 7, 2020, the disclosure of which is incorporated herein by reference in its entirety as part of the present application.

### FIELD OF INVENTION

The present invention relates to a robotic lawn mower having non-traditional cutters or blades. More particularly, it relates to a lawn mower having at least one set of cutting tools or cutters which is semi-rigid and semi-flexible and may be generally in a form of a single rod or twisted cable or wires, that is normally not considered as a blade with sharp edges for traditional lawn mowers.

### BACKGROUND OF INVENTION

Generally, a lawn mower is defined as a machine having rotatable blades which are adjustable for height with respect to the ground, and the machine is capable of moving around on the ground (or over lawns) so that the rotatable blades may cut the grass with smooth appearance and uniform height, when being driven manually, or by combustion engine, as well as by electric power or batteries, etc. Therefore, the basic or essential elements of a lawn mower are: (1) at least a rotatable blade being adjustably mounted on a vehicle or movable carrying platform; (2) driving mechanism for moving the vehicle and the blade; and (3) power source for powering the moving vehicle and/or the rotation of the blades; wherein the vehicle or movable carrying platform may include a chassis or a baseboard and/or a housing to hold everything or every parts together.

The current trends of lawn mowers are robotic, that is controllable and/or automatically movable; but in any event, the key concerns of lawn mowers are the efficacy of cutting the grass over various types of lawns having various conditions, such as, the sizes, shapes, boundaries, concaves/uneven grounds or levels of grounds, as well as dryness or wetness of grass, etc. Hence, many improvements of lawn mowers have been made with respect to how those elements can work together more efficiently. Now, the focus of improvements may be not only on robotic operation, but also artificial intelligent, aka AI, operation.

### SUMMARY OF INVENTION

According to the present invention, a lawn mower comprises a chassis for carrying thereon at least a set of rotatable cutting tools which is mounted in the front section of the chassis, said cutting tools being in a form of semi rigid and semi flexible rod or twisted cable or wires; at least two wheels mounted on the sides of the chassis; and driving mechanism for moving the lawn mower around; and rotation mechanism for rotating the cutting tools. The lawn mower includes at least a power source for powering up the driving mechanism and rotation mechanism, which may be preferably a bank of rechargeable batteries, and a control unit for controlling the rotation of the cutting tools at desired speeds or in a range of adjustable desired speeds as being adopted and suitable for cutting or mowing grass of the lawns in various conditions as well as the adjustment of the height of the cutting tools with respect to the grass of the lawns, wherein the height of the cutting tools is adjustable according to predetermined patterns of lawns where the mower moves around, and is adjustable in response to any random conditions of the lawn.

Alternatively, the driving mechanism for driving the mower may be powered by the same power source or by a separate power source from the power source of the rotation mechanism for rotating the cutting tools; and a separate control unit is provided for controlling the movement of the wheels in any or all directions in accordance with the predetermined patterns of the lawn, without necessity of turning the front section of the chassis of the mower.

According to the present invention, the cutting tools may be in the form of a single rod or a twisted cable or wires, and the set of cutting tools or cutting assembly is connected to the shaft of the rotation mechanism for rotating the cutting tools. The rotation mechanism for rotating the cutting tools may be an electric motor that is operable as powered by the power source, i.e., batteries or rechargeable batteries, etc.

Further according to the present invention, the cutting tools may be in the form of a cross, and the center of the cross of the cutting tools is connected to the shaft of the rotation mechanism for rotating the cutting tools, i.e., to the electric motor.

Still further, the cutting tools may be alternatively a plurality of uniformly spaced apart rods or twisted cable or wires, which may be three, five, six, eight or more rods or twisted cable or wires uniformly arranged around the rotating shaft, such as, be mounted on a disc connected to the rotating shaft. Moreover, of all the arrangement of robs or cable or wires of the cutting tools, each of the rods may be of a cross section of triangle, or an irregular cross-section which may be of desired flexibility and rigidity. Certainly, the cutting tools could be a blade with sharp edge.

According to the present invention, there are preferably four wheels mounted on the sides of the chassis, i.e., two at each side. Each of the wheels is independently operated and driven by an electronic motor of the driving mechanism under the control of the control unit for controlling the movement of the wheels. Each of the wheels is connected to the chassis through a suspension that acts in response to the various conditions of the ground or the lawns under the control of the control unit for controlling the movement of the wheels, such as the adjustment of power output, speeds, and direction according to the predetermined patterns of the lawn, or in response to certain random or instant condition of the lawn.

Details of the present invention may be understood and will be discussed hereinafter in connection with the accompanying drawings.

### BRIEF DESCRIPTION OF THE DRAWINGS

FIG. 1a illustrates a perspective view of the lawn mower or robotic lawn mower of the basic embodiment of the present invention.

FIGS. 1b and 1c show, respectively, the front view and top view of the lawn mower or robotic lawn mower of the present invention.

FIG. 2a illustrates the main components of the lawn mower or robotic lawn mower of the present invention.

FIGS. 2b and 2c show, respectively, the mounting of the main components of the lawn mower or robotic lawn mower of the present invention from various views.

FIG. 3a illustrates the mounting of a sample of cutting tools or a cutting assembly in accordance with the present invention.

FIG. 3b to 3e illustrate, respectively, alternative samples of the cutting tools according to the present invention.

FIG. 4a illustrates the mounting of a moving wheel according to the present invention;

FIGS. 4b and 4c illustrate, respectively, the details of the driving motor 25 assembly and suspension for the moving wheels of the present invention.

FIGS. 4d to 4g are respectively illustrative of the movement of the moving wheels of the robotic lawn mower according to the present invention, in forward and backward, as well as left and right directions.

FIGS. 4h, 4j, 4k, and 4m, are respectively illustrative of the movement of the mowing wheels of the robotic lawn mower of the present invention in diagonal directions.

FIGS. 4n and 4p are illustrative of the left and right turnings of the mowing wheels of the robotic lawn mower of the present invention.

FIG. 5 illustrates the block diagram of the control unit or units of the robotic lawn mower of the present invention for providing control modes of the operations of motors of the cutting tools and moving wheels.

FIG. 6 illustrates the flow chart of the operation or control of the robotic lawn mower of the present invention.

FIG. 7 shows the arrangement of a sensing and/or detecting system of the present invention, showing possible mountings of the components of the system.

FIGS. 8a, 8b and 8c show an alternative embodiment of moving wheels of the present invention.

FIG. 9 illustrates an alternative arrangement of rechargeable batteries as the power source of the present invention.

### DETAILED DESCRIPTION OF THE INVENTION

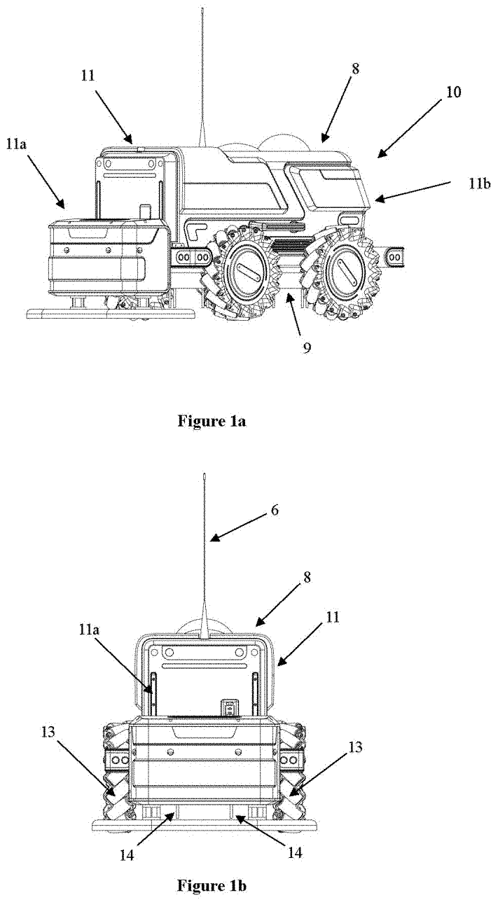

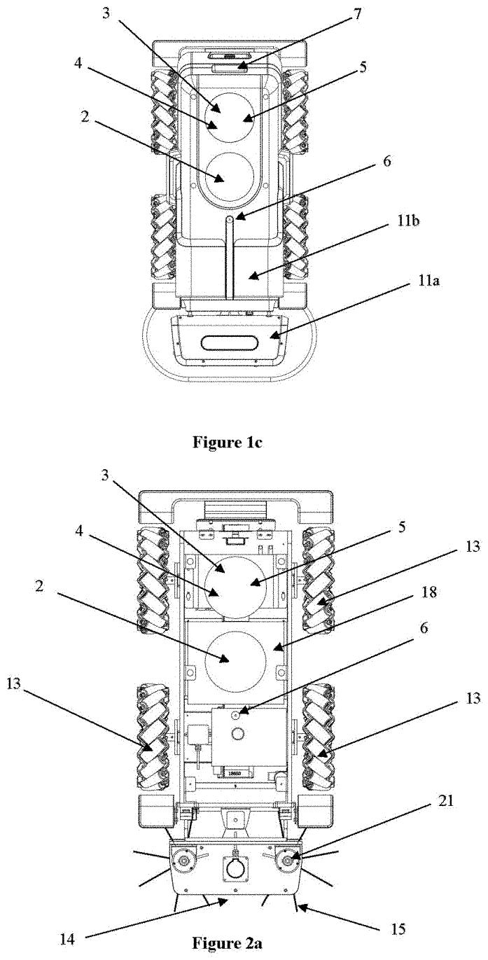

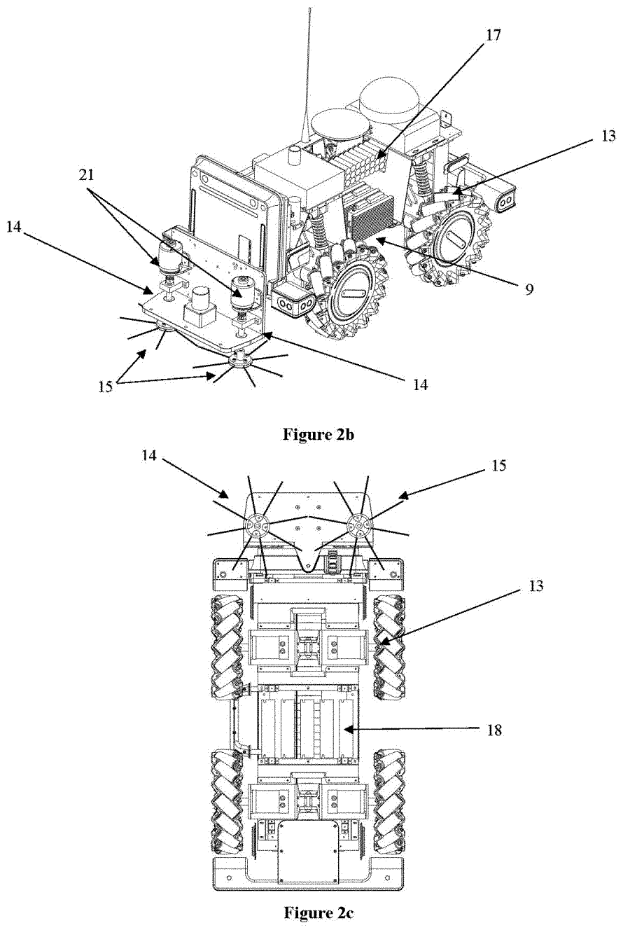

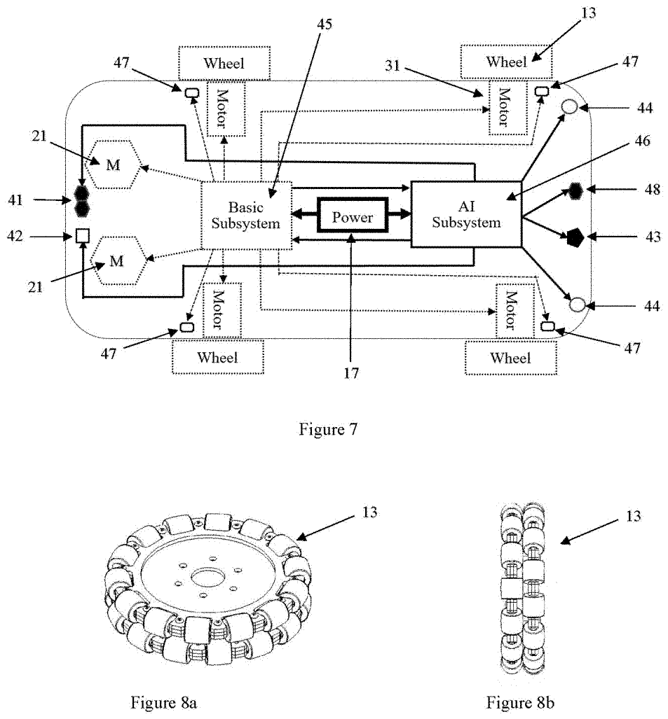

Generally, the robotic lawn mower 10 of the present invention as shown in FIGS. 1a to 1c comprises a housing 11 for holding the main components of the lawn mower 10 therein, a moving assembly 12 usually having four moving wheels 13 as an example, and a cutting or mowing assembly 14 having one or more sets of cutting tools or cutters 15 (as seen in FIGS. 2a to 2c). Other components are at least one power source 16 including rechargeable battery or batteries 17, and operation control board or boards or units 18 (as seen in FIGS. 2a to 2c). In addition, there are provided with suspension mechanism 19 (seen in FIG. 2b) for the moving wheels adopted to respond and act to various conditions of the lawn or ground, as well as other necessary mounting structural elements or members. Moreover, a sensing and/or detecting system 20 are provided around the housing or provided at least in the front and rear sections of the mower for detecting the conditions of the grass and ground of the lawn being mowed during the operation of the lawn mower, as described in details in connection with FIG. 7.

FIG. 1a is a perspective view of the lawn mower of the basic embodiment of the present invention. The housing 11 is illustrative only, and it may be designed to any shapes as long as being suitable to hold the components of the lawn mower and being of any kinds or styles of industrial designs. Preferably, it may include two compartments 11a and 11b in the one housing 11, one of which 11a is for the cutting tools 15 and the other compartment 11b is for other main components, such as, the power source 16, control unit or units 18. The two compartments 11a and 11b may also be separable, and the compartment 11a for the cutting tools 15 is provided in the front section of the mower and is movable up and down with respect to the other compartment 11b, thereby allowing the vertical height adjustment of the cutting tools 15 with respect to the ground or lawn. A chassis or baseboard 9 is a carrying platform for mounting the components and serves as or fits to the bottom of the housing 11, and the chassis 9 is designed in consideration of structural stability, strength and/or durability to support and hold those components thereon. The housing 11 has an upper portion 8 that is formed of any suitable and durable materials and at least offers protection to the components held therein.

FIGS. 1b and 1c show, respectively, the front view and top view of the lawn mower of the present invention. FIG. 1b shows two sets of cutting tools 15 or two cutting assembly 14 that are mounted in the compartment 11a in the front section of the chassis 9 of the lawn mower, as defined in the forward moving direction; and the moving wheels 13 are connected to the chassis or baseboard 9 of the housing 11 through suitable mounting structure or suspension mechanism 19, along the sides of the other compartment 11b of the housing 11 as viewed in the forward moving direction. As seen in FIG. 1c, some additional features may include the operation buttons 7, antenna 6, WiFi 5 or Bluetooth 4, and any other available wireless connections or communication devices 3, as well as a viewing or transparent window for a surveillance or monitoring camera 2, that are illustrative and optional because they may also be provided at any part of the housing 11.

FIG. 2a illustrates generally the possible arrangement of those main components of the lawn mower according to the basic embodiment of the present invention. There may be one set or two separate sets of rechargeable batteries 17, one or part of which is for operating the cutting assembly 14, or rather provides power to the motor or motors 21 of the cutting tools 15, and the other of which is for providing power to the motors 31 of the moving wheels 13 of the moving assembly 12. However, there may be just one set or bank of rechargeable batteries for powering both of the cutting assembly 14 and the driving or moving assembly 12. The motor or each of the motors 21 of the cutting assembly 14 will rotate or turn the cutting tools 15 at a desired speed or in a range of desired speeds under the control of the control board or unit 18 in order to cut or mow the grass in response to the control signals according to predetermined patterns of a lawn or any feedbacks of the grass and ground conditions from the sensing or detecting system 20. An operation control board or unit 18 is shown in FIG. 2a, but there may be two or more control boards or units, etc., depending on the necessary functions for the various operations of the lawn mower. That is to say the control unit 18 could be just one part or component which is designed to control the performance of all the functions, or could be two or more parts or components that control the performance of respective functions of the cutting or mowing assembly 14 and moving assembly 12.

FIGS. 2b and 2c show, respectively, how those components of the lawn mower 10 are mounted on the chassis or baseboard 9 of the robotic lawn mower of the present invention. Again, the arrangement or compartments of the components on the chassis or baseboard 9 are exemplary of possible options. The connections thereof are electrically through wiring or connection circuit board or boards, that are subject for other suitable designs.

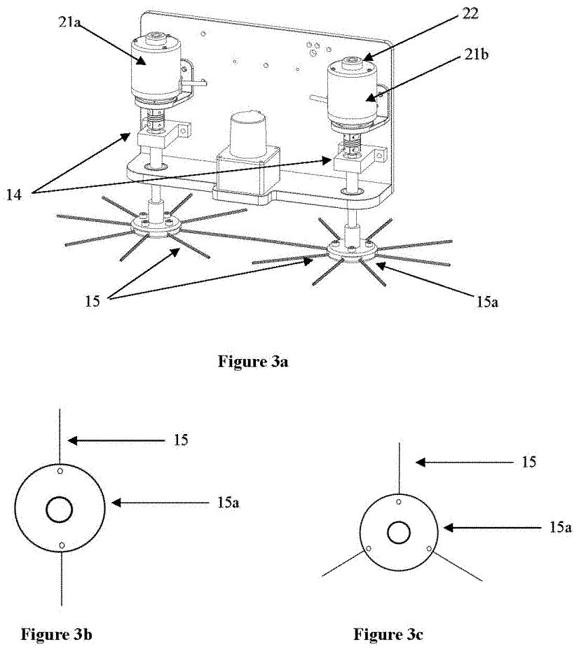

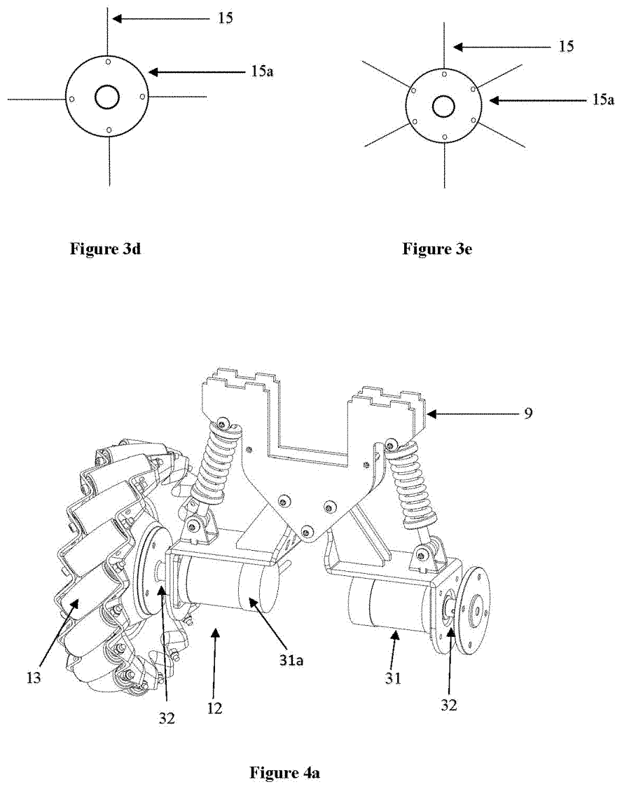

FIG. 3a illustrates the mounting of an example of cutting tools 15 or cutting assembly 14 in accordance with the present invention. Two sets of cutting tools 15 are shown in FIG. 3a, and the respective motor assemblies 21a and 21b or the motor assembly box # are mounted through each of the two respective openings of the chassis as seen in FIG. 2b. The cutting tools 15 include a support disc 15a that is connected centrally or co-axially to the shaft 22 of the motor 21 as in the motor assembly 21a or 21b, and as shown, the cutting tools 15 are in the form of eight twisted cables or wires uniformly allocated around the support disc 15a. Each of the twisted cables or wires 15 is made of semi rigid and semi flexible material, such as stainless steel, or any material that is generally durable and strong enough to sustain the impact of the grass or the like at relatively high rotating speed of the cutting tools 15, thereby cutting the grass. As compared with traditional blade of lawn mowers, the cutting tools or cutters 15 of the present invention do not have very sharp edges, but still can cut the grass efficiently. Nonetheless, any traditional blade with sharp edge may also be an optional or exchangeable set of cutting tools, especially for large areas of lawns, such as football fields or golf courses. Moreover, other alternatives of the twisted cables or wires of the cutting tools may be short rods of stainless steel or similar materials that are durable and strong enough to sustain the impacts of the grass when turning at relatively high speed or speeds. Each of the rods may be of a cross section of square, triangle or even rectangular, or twisted thereof. Again, there is no need to have very sharp edges as traditional blades of lawn mowers are.

The semi rigid and semi flexible materials also have advantages of directly contacting solid or hard substances, such as walls, fences, and etc., without breaking them. This will benefit and increase significantly the mowing efficiency. Traditional type of blades with sharp edges of lawn mowers will normally leave certain areas of grass uncuttable, that is, between the mower and the hard substances, and may need a timer to do a complete mowing job.

FIG. 3b to 3e illustrate, respectively, alternative examples of the cutting tools 15 of the present invention. As seen, the cutting tools 15 may be as simple as a single or two cables or rods, as well as three, four, five, six, or even more that are usually uniformly allocated round the periphery of the support disc 15a which is usually round in shape. However, it can be understood that a support disc 15a may be in any other forms so long as it may support the rods or twisted cables or wires or the like uniformly such that they can rotate with respect to the center of the disc 15a as co-axial with the shaft 22 of the motor 21.

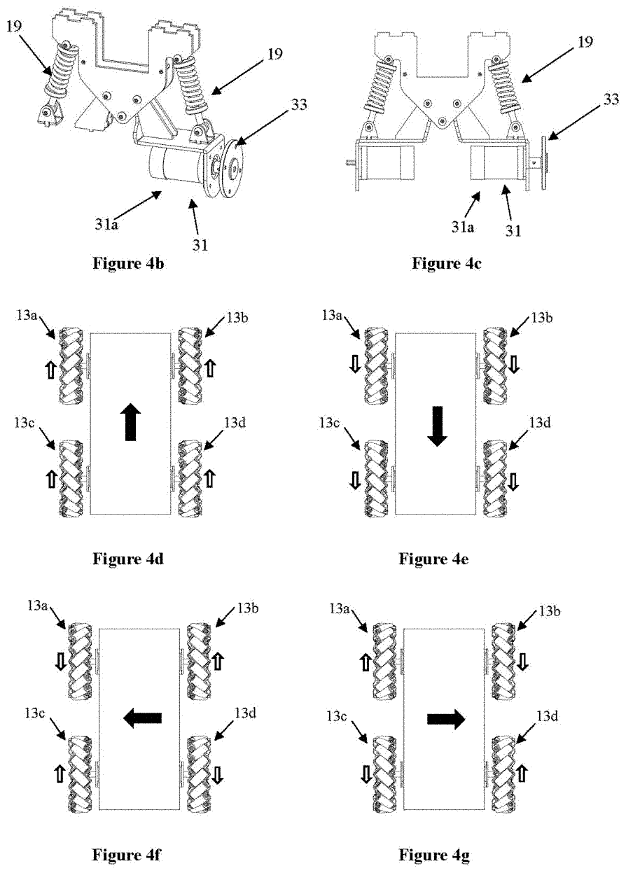

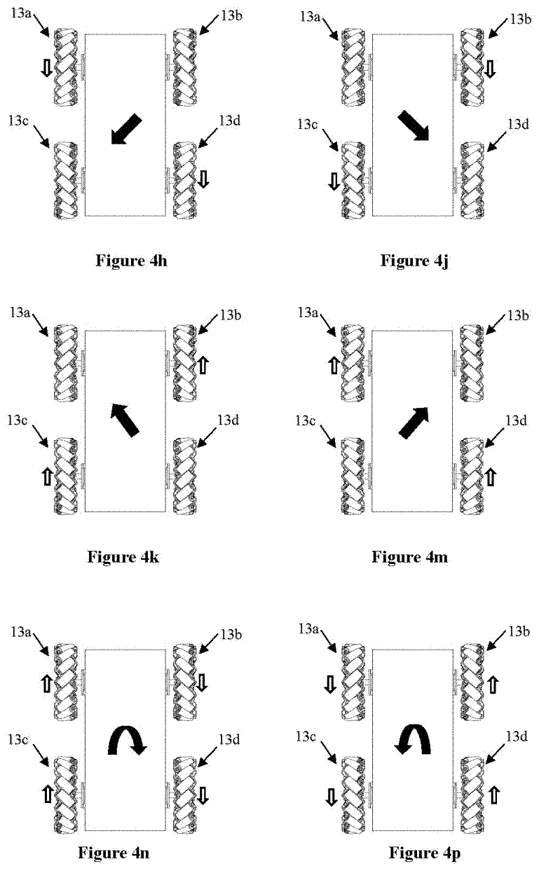

FIG. 4a illustrates the more details of the mounting of one of the moving wheels 13 of the moving assembly 12 of the present invention. The moving wheel 13 is connected to or mounted on the chassis 9 of the housing 11 of the lawn mower 10 through a motor assembly 31a and suspension mechanism 19. The motor assembly 31a is illustrated in the box wherein a driving motor 31 is accommodated and the motor has a shaft 32 connecting co-axially with the wheel 13 at one end thereof, and the motor 31 is connected electrically through wiring to the control board or unit 18 and the rechargeable battery (not shown). In response to any of conditions of the grass or ground, the motor 31 will drive the wheel 13 in a desired direction under the control of the control unit 18 which generates control signals to operate the motor 31. The operation of the control unit 18 will be discussed hereinafter.

FIGS. 4b and 4c illustrate further the motor assembly 31a of driving motor 31 for the moving wheel 13 of the present invention. Inside the motor assembly or accommodating box 31a, the driving motor 31 and its associated accessories are installed, and has various connecting wiring to be connected electrically to the control unit 18 (not shown FIGS. 4b and 4c); and on the accommodating box of the motor 31a, a support piece 33 extends (as seen in FIGS. 4a to 4c), protruding away from the box, which serves as a basic piece for connecting with the chassis directly or through a suspension mechanism 19. It can be understood that the motor assembly 21a for the cutting tools 15 may be similar with the motor assembly 31a of the moving wheels 13, and thus, the description of the motor assembly 21a of the cutting tools 15 is omitted. However, other possible form or arrangement of motor assembly 31a may be adopted so long as they are operated independently and cooperatively.

Regardless of any possible arrangement of the motor assembly 31a for the moving wheels 13, an important feature of the present invention is the capability of those moving wheels 13 to move the lawn mower 10 in any or all directions with or without turning the front section or head of the lawn mower 10, and the wheels may be Mecanum wheels adopted in this basic embodiment of the present invention as shown in FIG. 4a or Omni wheels shown in FIGS. 8a to 8c. The details of the movement of the moving wheels 13 under the control will be described hereinafter.

The desired capability of the moving wheels may be seen or illustrated in FIGS. 4d to 4g for the movement of the moving wheels 13 of the lawn mower 10 in any or either of directions of forward and/or backward as well as left and/or right. The adoption of such Mecanum wheels may fulfill the requirements of the aforesaid movement. It is also easy to understand that the movement of the lawn mower in forward and/or backward directions will require all of the four wheels 13 or 13a to 13d to move or to be driven to move in the same direction as shown in FIGS. 4d and 4e. The cutting assembly 14 or the cutting tools 15 may keep on rotating to cut the grass while the mower 10 moves over the grass on the ground. The movement of the lawn mower 10 in the left direction will require, respectively, that the two wheels 13a, 13c on the left side move or rotate toward each other, while the two wheels 13b, 13d on the right side move or rotate away from each other as the arrows indicate. Likewise, the movement of the lawn mower 10 in the right direction will require, respectively, that the two wheels 13b, 13d on the right side move or rotate toward each other, while the two wheels 13a, 13c on the left side move or rotate away from each other, as the arrows indicate in FIGS. 4f and 4g.

FIGS. 4h and 4j illustrate, respectively, the movement of the robotic lawn mower 10 in a direction somewhat diagonally backwards, as the narrows indicate. If the movement of the lawn mower 10 is somewhat leftwards and backwards, the two of the four wheels, i.e., the left front wheel 13a and the right rear wheel 13d that are diagonally positioned on each side, move or rotate backwards in the same direction, while the other two wheels 13b, 13c being diagonally positioned do not rotate as seen in FIG. 4h. If the movement of the lawn mower 10 is somewhat rightwards and backwards, the two of the four wheels, i.e., the right front wheel 13b and the left rear wheel 13c that are diagonally positioned on each side, move or rotate backwards in the same direction, while the other two wheels 13a, 13d being diagonally positioned do not rotate as seen in FIG. 4j. Moreover, different driving powers may be applied to the two rotating wheels so that the robotic lawn mower 10 will move in any desired diagonal directions backwards. All of the movements of the lawn mower 10 will be under the control of the control unit 18.

Similarly, FIGS. 4k and 4m illustrate, respectively, the desired movement of the lawn mower 10 in the somewhat diagonally forward directions. That is, if the lawn mower is desired to move somewhat leftwards and forwards, the two of the four wheels, i.e., the left rear wheel 13c and the right front wheel 13b that are diagonally positioned on each side, move or rotate forwards in the same direction, while the other two wheels 13a, 13d being diagonally positioned do not rotate as seen in FIG. 4k; and if the lawn mower 10 needs to move somewhat rightwards and forwards, the two of the four wheels, i.e., the right rear wheel 13d and the left front wheel 13a that are diagonally positioned on each side, move or rotate forwards in the same direction, while the other two wheels 13b, 13c being diagonally positioned do not rotate as seen in FIG. 4m. Again, different driving powers may apply to the two wheels so that the lawn mower will move in any desired diagonal directions.

As described above, it is possible for the lawn mower 10 of the present invention keeps on cutting the grass, while moving around in any desired directions without turning the head or front of the lawn mower. Sometimes, it is still desired to turn the head or front of the lawn mower 10 so that the cutting tools 15 mounted in the front section of the mower 10 may cut the grass at the edges of the lawn. As seen in FIG. 4n, the right turning can be performed by having the two wheels 13b, 13d on the right side to move or rotate backward, while the two wheels 13a, 13c on the left side to move or rotate forward as the arrows indicate. Similarly, the left turning can be performed by having the two wheels 13a, 13c on the left side to move or rotate backward, while the two wheels 13b, 13d on the right side to move or rotate forward as the arrows indicate. Then, it can be understood that the lawn mower of the present invention may mow or cut the grass over the entire piece of lawn even close to the edges of the lawn without need to use a trimer.

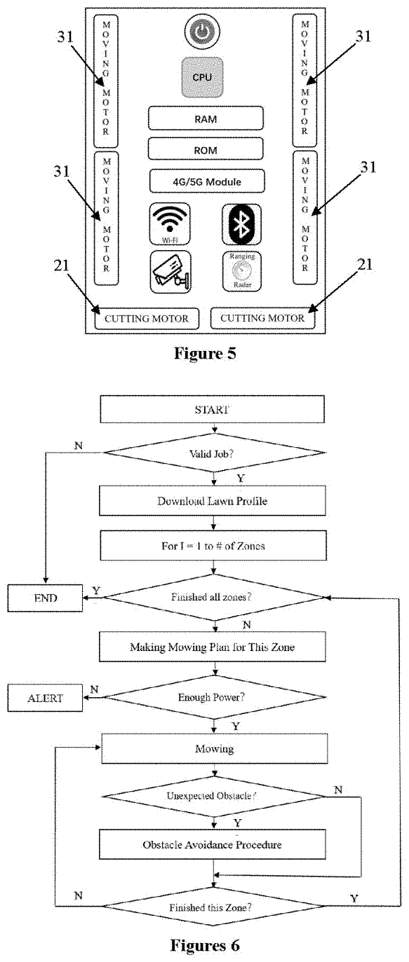

FIG. 5 illustrates the block diagram of the control unit or units 18 of the robotic lawn mower of the present invention. The control unit 18 is the operation system of the lawn mower 10, and the control unit 18 or operation system comprises at least CPU, RAM, ROM for storing and processing operational programs and signals with respect to various operational modes of the motors that need to operate, respectively, the cutting tools and moving wheels. The basic and/or predetermined operational modes are pre-installed as operational programs, and will be selected to operate the motors when the specific piece of lawn is determined with the received or retrieved lawn profile data of this piece of lawn. The control unit 18 also comprises various communications means, such as, Wi-Fi, Bluetooth, and 4G/5G modules, that establish wireless communication and/or telecommunication with remote database or control center (not shown) and transmit control demand signals to and receive lawn profile data from the remote database and control center to determine proper operation and to adjust operation modes with respect to this specific piece of lawn. That is to say that the sensors or cameras are provided in connection with the control unit so as to provide real time of grass conditions, and to adjust retrieved operation mode or modes in response thereto. Then, the CPU will issue and send the operational signals to the respective motors for the cutting tools and/or moving wheels.

FIG. 6 illustrates the flow chart of the operation or control of the robotic lawn mower of the present invention. Before a robotic lawn mower starts a mowing job, the control unit or the operation system of the lawn mower will first verify numbers of things, as illustrated in FIG. 6, which include if it is the right or correct lawn to be mowed, the right date, authorized user, and the conditions of the mower, and so on. After everything is checked out and verified correctly, the robotic lawn mower starts working in accordance with the specific lawn profile data and desired or predetermined operation mode or modes of the lawn mower. The lawn profile data describes the particular piece of lawn in great details. The operation mode or modes will be retrieved and sent to the CPU to start operations of the motors under the control. That is the robotic lawn mower is ready to perform the mowing job for all zones of the particular lawn. The robotic lawn mower will first use the data to generate a mowing plan for the zones of the lawn to be mowed and check whether the power source is enough for mowing the particular lawn. If everything is checked OK, the robotic lawn mower starts the mowing job as guided and controlled by the mowing plan. If any unexpected obstacle is detected or found, the robotic lawn mower will initiate the obstacle avoidance procedure in response to and to handle the situation. Once the obstacle is overcome, the lawn mower will then continue on to finish the job of the particular zone or zones of the lawn as the predetermined operation mode or the scheduled mowing plan indicates. It will repeat this routine for each of remaining zones until all zones are completed, i.e., finishing the mowing jobs.

FIG. 7 shows schematically the arrangement of a sensing and/or detecting system 20 of the present invention, showing the mountings of the respective parts of the sensing and detecting system 20. It includes at least a basic subsystem 45 and AI system 46 that are parts of the operation system 40 of the control unit 18, a front binocular camera 41, a laser ranging radar 42, a back or rear camera 43, and a pair of ultrasonic ranging sensors 44, as well as a surveillance camera 47 and anti-drop sensors 48 each of which is near each of the moving wheels 13. The laser ranging radar 42, the front binocular camera 41, the back camera 43, the ultrasonic ranging sensors 44, the surveillance camera 47 and the anti-drop sensors 48 start working once the lawn mower 10 starts working as guided and initiated by the mowing plan after verification and checking out the various conditions as stated above. All of the laser ranging radar 42, the front binocular camera 41, the back camera 43, the ultrasonic ranging sensors 44, and the anti-drop sensors 48, as well as the surveillance camera 47 will send to the AI subsystem 46 of the operation system 40 the real time or actual conditions of the grass of the lawn when the lawn mower 10 continues the mowing jobs over a particular piece of lawn; and the AI subsystem 46 generates a signal representing the actual condition or an obstacle, if so detected, to the basic subsystem 45, indicative of any adjustment operation or avoidance of any obstacles; and then the basic subsystem 45 will send adjustment signals to the respective motors 21, 31 of the cutting tools 15 and/or moving wheels 13. Afterwards, the lawn mower 10 will continue the wowing jobs based on the remaining mowing plan to finish the jobs. A power source will be needed for all of the parts of the sensing and detecting system 20, and it may be a separate power source or it may be the same power source or sources for the operation of the cutting tools 15 and/or moving wheels 13.

FIGS. 8a, 8b and 8c show, respectively, different views of an alternative embodiment of moving wheels of the present invention, i.e., Omni wheels. They just show the details of such wheels, including uniformly allocated rotatable blocks along each side of each of the wheels, i.e., each wheel having two parallel side sections. FIG. 8a shows the inner side of the wheel, i.e., facing the housing, and FIG. 8b shows the outer side of the wheel. Figure Sc shows the side view of the wheel. Each of the rotatable blocks may rotate based on bearings mounted and connected on each of the parallel side sections of the wheel, and as seen in FIG. 8c, the rotatable blocks are received and mounted in recesses of the side section of the wheel. Therefore, the rotatable blocks may move somewhat horizontally or perpendicularly with respect to the rotation of the wheel. That is the rotatable blocks will rotate, as so desired and controlled, to accomplish the movements as described above and illustrated in FIGS. 4d to 4g, FIGS. 4h and 4j, FIGS. 4k and 4m, as well as FIGS. 4n and 4p. Accordingly, the lawn mower may move in all directions or turning as controlled by the control unit and/or guided by the mowing plan as so chosen or retried for the operational data.

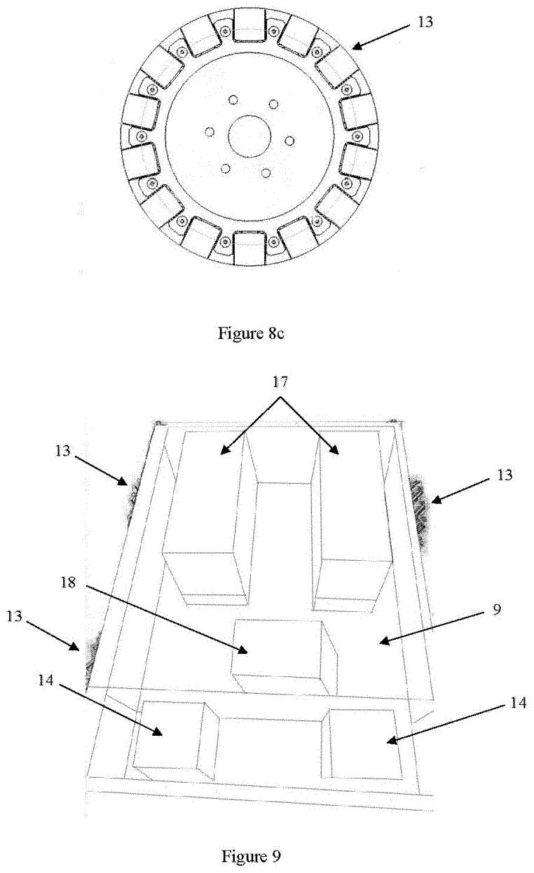

FIG. 9 illustrates an alternative arrangement of rechargeable batteries or the power source as well as the control board, as the main components of the lawn mower of the present invention. It comprises two sets of batteries or two power sources, instead of one set of batteries or power source as in FIGS. 2a to 2c. As compared with the arrangement of the main components in FIGS. 2a to 2c, it just indicates that the arrangement of all components of the lawn mower should be balanced and convenient in consideration of particular designs of the components or parts or desired arrangement thereof to be suitable of or fit any desired profile of lawn mowers, as well as how many rechargeable batteries or power sources required which is designed in consideration of capacity of the lawn mower. In any event, power sources or rechargeable batteries are the most weighted and occupied more space in the robotic lawn mowers.

1. A robotic lawn mower, comprising:
a housing including an upper cover portion and a chassis as a carrying platform;
a mowing assembly being mounted on the front section of the chassis and having at least a set of rotatable cutting tools, said cutting tools being formed of semi rigid and semi flexible material;
a moving assembly having at least two moving wheels that are mounted on both sides of the chassis, and are capable of moving in any directions;
a driving mechanism for driving the moving wheels;
a rotation mechanism for rotating the cutting tools; and
at least one control unit for controlling the operation of said driving mechanism for driving the moving wheels of the mower and said rotation mechanism for rotating the cutting tools; and
a power source providing power to the driving mechanism for driving the mower, the rotation mechanism for rotating the cutting tools, and the at least one control unit.

2. The robotic lawn mower of claim 1, wherein said control unit provides operation control of the rotation of the cutting tools at a range of predetermined speeds and adjustment of the cutting tools, and provides operation control of the movement of the moving wheels at a range of predetermined speeds and adjustment of the moving wheels.

3. The robotic lawn mower of claim 1, wherein said power source includes a set of rechargeable batteries; wherein said rotation mechanism for rotating the cutting tools includes at least one cutting motor assembly having a motor to rotate the set of cutting tools; and wherein said driving mechanism for driving the moving wheels includes at least two moving motor assemblies, each having a motor to drive one of the moving wheels.

4. The robotic lawn mower of claim 3, wherein the set of cutting tools of the cutting assembly is connected co-axially to the shaft of the motor of the cutting motor assembly; and wherein each of the moving wheels is connected co-axially to the shaft of the moving motor assembly.

5. The robotic lawn mower of claim 1, wherein each of said cutting tools is in one of the forms of a single rod and a twisted cable or wires.

6. The robotic lawn mower of claim 5, wherein said at least one cutting assembly includes a support disc having the cutting tools mounted thereon, and wherein said cutting tools are in one of the forms of two or more rods and two or more twisted cables or wires that are uniformly arranged around the support disc.

7. The robotic lawn mower of claim 5, wherein the rod of each of the cutting tools has a cross section being selected from one of forms of triangle, round, square and an irregular shape.

8. The robotic lawn mower of claim 1, wherein said moving assembly has four moving wheels mounted on the chassis of the housing, two of said moving wheels being on each side of the housing.

9. The robotic lawn mower of claim 8, wherein each of the moving wheels is independently operable and cooperatively with other moving wheels, thereby enabling the movement of the robotic lawn mower in any directions, under the control of the control unit so as to act in response to various conditions of the grounds of lawns randomly and according to predetermined patterns of the lawns.

10. The robotic lawn mower of claim 1, wherein said control unit comprises at least a CPU, RAM, and ROM, and wireless communication means being capable of establishing communication with remote database or control centers; wherein said ROM receives and stores profile data of predetermined patterns of lawns and programs collective of a plurality of predetermined mowing plans with respect to particular lawns, and wherein said CPU and RAM retrieve one of the predetermined mowing plans and provide control operation with respect to the cutting assembly and moving assembly.

11. The robotic lawn mower of claim 10, wherein said wireless communication means include Wi-Fi, Bluetooth, and 4G/5G.

12. The robotic lawn mower of claim 10, wherein said control unit contains an operation system that communicates with the remote database or control center to download and update profile data of lawns and operation data, in order to determine a predetermined pattern of a piece of lawn and to select a corresponding predetermined mowing plan to control the operation of the mower.

13. The robotic lawn mower of claim 1, further comprising a sensing and detecting system, which includes at least a basic subsystem for controlling and adjusting the operation of the cutting assembly and moving assembly; a front binocular camera and laser ranging radar; a back camera and ultrasonic ranging sensors; as well as an AI subsystem for receiving real time conditions of the lawn from said laser ranging radar, said front binocular camera, said back camera, and said ultrasonic ranging sensor.

14. The robotic lawn mower of claim 13, wherein said AI subsystem generates real time condition data to check against the predetermined mowing plan so as to determine any possible adjustment, thereby providing adjustment to the cutting assembly and moving assembly.

15. A robotic lawn mower, comprising:
a housing including an upper cover portion and a chassis as a carrying platform;
a mowing assembly being mounted on the front section of the chassis and having at least two sets of rotatable cutting tools, said cutting tools being formed of semi rigid and semi flexible material;
a moving assembly having at least four moving wheels that are mounted on both sides of the chassis, and are capable of moving in any directions without turning the direction of the robotic lawn mower;
a driving mechanism for driving independently each of the moving wheels;
a rotation mechanism for rotating independently each set of the cutting tools; and
a control unit for controlling the operation of said driving mechanism for driving the moving wheels of the mower and said rotation mechanism for rotating the cutting tools; and
a power source providing power to the driving mechanism for driving the mower, the rotation mechanism for rotating the cutting tools, and the control unit.

16. The robotic lawn mower of claim 15, wherein the housing has a front compartment and main compartment, and the mowing assembly is mounted in the front compartment.

17. The robotic lawn mower of claim 16, wherein the front compartment is movable vertically with respect to the main compartment so as to adjust the cutting tools of the mowing assembly mounted in the front compartment.

18. The robotic lawn mower of claim 15, wherein each of the four moving wheels is capable of operating independently from the other moving wheels under the control of the control unit so that the mower is capable of moving in any or all directions without turning the front of the mower in accordance with a predetermined mowing plan stored in the control unit representing a predetermined pattern of a specific piece of lawn.

19. The robotic lawn mower of claim 15, further comprising a suspension mechanism for mounting each of the moving wheels to the chassis, and anti-drop sensors to detect real time conditions of lawn.

20. The robotic lawn mower of claim 19, further comprising a sensing and detecting system including a basic subsystem and AI system for operation processing as well as a front binocular camera, a laser ranging radar, a rear camera, a pair of ultrasonic ranging sensors, and a surveillance camera for detecting real time conditions of lawn.
